(19) United States
(12) Patent Application Publication
(10) Pub. No.: US 2013/0257575 A1
(43) Pub. Date: Oct. 3, 2013

(54) COIL HAVING LOW EFFECTIVE CAPACITANCE AND MAGNETIC DEVICES INCLUDING SAME

(71) Applicants: Alexander TIMASHOV, Rehovot (IL); Eli KATZIR, Herzelia Pituach (IL); Oxana SAVVATYEYEV, Holon (IL)

(72) Inventors: Alexander TIMASHOV, Rehovot (IL); Eli KATZIR, Herzelia Pituach (IL); Oxana SAVVATYEYEV, Holon (IL)

(21) Appl. No.: 13/437,974

(22) Filed: Apr. 3, 2012

(51) Int. Cl. H01F 5/00

(52) U.S. Cl. 336/200

(57) ABSTRACT

A coil of a magnetic device comprising a conductor having its plurality of turns arranged in a plurality of conductive layers, wherein at least two non-innermost and electrically consecutive turns of the conductor are arranged in different conductive layers, and a magnetic device including same.

### BACKGROUND OF THE INVENTION

Magnetic devices such as inductors, transformers, integrated magnetic device, solenoids, common mode chokes, loudspeakers, motors etc., typically include at least one coil of conducting material, typically winded over a magnetic core, such as a ferrite core. Limited space at devices such as Smartphones and laptops may impose stringent dimension requirements on such magnetic devices. Planar magnetic devices may include substantially planar coils, which may be disposed on a printed circuit board (PCB), or manufactured as layers of frames of conductive metal, such as copper, brass, aluminum, or various alloy frames, the layers separated and insulated by a dielectric insulating sheet. The coils may be arranged in layers of flat spiral turns.

Theoretically, assuming that an ideal sinusoidal alternating current (AC) signal is applied, the frequency of the signal should be kept below the resonance frequency of the magnetic device to ensure proper operation of the magnetic device for most applications. Practically, however, the electrical signal applied to practical magnetic devices is typically not an ideal sinusoidal AC signal, but rather a distorted sine wave that may have significant energy levels at, for example, the second and third harmonies of the signal. Therefore, the practical working frequency of the magnetic device may typically be limited to one third of the resonance frequency of the magnetic device.

Reference is now made to FIG. 1 which depicts an illustration of typical prior art arrangement of a double layer magnetic planar coil 100. According to the prior art arrangement, a first conductor 110 of planar coil 100 has inward spiral turns that are arranged in a first conductive layer, the turns run from input/output (I/O) terminal 190 disposed at the perimeter of the windings to a connecting terminal 140 disposed proximal to the middle of coil 100. A second conductor 120 of planar coil 100 has outward spiral turns that are arranged in a second conductive layer, the turns run from connecting terminal 140 disposed proximal to the middle of coil 100 to second input/output (I/O) terminal 195 disposed at the perimeter of the windings. The first 110 and second 120 conductors are eclectically interconnected at substantially the innermost point of section 130 of conductors 110 and 120, to form a single, electrically continuous, planar coil 100. For example, when implemented on a PCB, the first 110 and second 120 conductors may be disposed on two opposite sides of the PCB and may be interconnected via through holes at the PCB, filled or coated with conductive materials, referred to as vias.

### SUMMARY OF THE INVENTION

According to embodiments of the present invention there is provided a coil of a magnetic device. The coil may include a conductor including a plurality of turns arranged in a plurality of conductive layers, wherein at least two non-innermost and electrically consecutive turns of the conductor are arranged in different conductive layers.

Furthermore, according to embodiments of the present invention, each pair of adjacent conductive layers may be separated by a dielectric insulating sheet.

Furthermore, according to embodiments of the present invention, the coil may be planar.

Furthermore, according to embodiments of the present invention, the plurality of turns may be arranged as inward spiral turns.

Furthermore, according to embodiments of the present invention, the conductor may change conductive layers at ends of the turns and return to a first external conductive layer after reaching a second external conductive layer, as the coil spirals inwardly.

Furthermore, according to embodiments of the present invention, the conductor may change conductive layers at ends of the turns except for turns arranged in external conductive layers, as the coil spirals inwardly.

Furthermore, according to embodiments of the present invention, the coil may include terminals at both ends of windings of the coil, wherein the terminals may be placed at or out of an outer circumference of the coil.

Furthermore, according to embodiments of the present invention, a free passage corridor may be formed on a selected conductive layer of the coil, the corridor being a radially extending section free of the plurality of turns, a longitudinal dimension of the corridor stretches at least from an inner point of the coil to a first terminal, wherein a segment of the conductor may extend outwardly from the inner point to the first terminal through the corridor.

Furthermore, according to embodiments of the present invention, the dielectric insulating sheet may be a dielectric substrate layer of a printed circuit board (PCB).

Furthermore, according to embodiments of the present invention, the coil may be implemented as frames of conductive material.

Furthermore, according to embodiments of the present invention, the dielectric insulating sheet may be a dielectric layer made of made of a material such as polytetrafluoroethylene, Nomex® polymer, FR-4, FR-1, CEM-1 or CEM-3 and poly(4,4′-oxydiphenylene-pyromellitimide) or other.

Furthermore, according to embodiments of the present invention, the inner turns of the coil may spiral inwardly on a first conductive layer and outwardly on a second conductive layer.

Furthermore, according to embodiments of the present invention, the coil may include a magnetic core, wherein the coil may be winded over the core.

Furthermore, according to embodiments of the present invention, the magnetic core may be an EI core, and the coil may be winded over the central prong of the core.

Furthermore, according to embodiments of the present invention, the magnetic core is a ferrite core.

According to embodiments of the present invention there is provided a magnetic device. The magnetic device may include a plurality of coils, at least two of the coils being inductively coupled to each other, wherein at least one of the coils includes a conductor having its plurality of turns arranged in a plurality of conductive layers, wherein at least two non-innermost and electrically consecutive turns of the conductor are arranged in different conductive layers.

Furthermore, according to embodiments of the present invention, each pair of adjacent conductive layers may be separated by a dielectric insulating sheet.

Furthermore, according to embodiments of the present invention, the plurality of turns of the conductor of the at least one coil may be arranged as inward spiral turns.

Furthermore, according to embodiments of the present invention, the conductor of the at least one coil may change conductive layers at ends of the turns and return to a first external conductive layer after reaching a second external conductive layer, as the at least one coil spirals inwardly.

Furthermore, according to embodiments of the present invention, the conductor of the at least one coil may changes conductive layers at ends of the turns except for turns arranged in external conductive layers, as the at least one coil spirals inwardly.

Furthermore, according to embodiments of the present invention, the inner turns of the at least one coil spirals inwardly on a first conductive layer and outwardly on a conductive second layer.

Furthermore, according to embodiments of the present invention, the magnetic device may be a transformer or an integrated magnetic device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of typical prior art arrangement of a double layer magnetic coil;

FIG. 2 is a schematic top view illustration of an exemplary double layer coil according to embodiments of the present invention;

FIG. 3 is a schematic partial cross section illustration of the exemplary double layer coil of FIG. 2 according to embodiments of the present invention;

FIG. 4 is a second schematic partial cross section illustration of the exemplary double layer coil of FIG. 2 according to embodiments of the present invention;

FIG. 5 is a schematic partial cross section illustration of an exemplary double layer coil according to embodiments of the present invention;

FIG. 6 is a schematic partial cross section illustration of an exemplary n-layer coil according to embodiments of the present invention;

FIG. 7 is a schematic partial cross section illustration of an exemplary n-layer coil according to embodiments of the present invention;

FIG. 8 is a schematic cross section illustration of an exemplary transformer assembled within an EI core according to embodiments of the present invention; and

FIGS. 9A and 9B depict an exemplary isometric exploded view, and isometric assembled view, respectively, of a lead-frame coil according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

As used herein, magnetic devices, also referred to as electromagnetic devices, may refer to any device that utilizes at least one coil of conductor that generates a magnetic field in response to electrical current that runs through it to operate.

As mentioned above, the practical working frequency of a magnetic device is typically limited to approximately one third of the resonance frequency of the magnetic device, due to significant energy levels carried at the second and third harmonies of the input AC signal. As known in the art, the resonance frequency of a circuit involving capacitors and inductors (LC circuit) equals:

$${f}_{r} = \frac{1}{2 π \sqrt{LC}} , \qquad ( 1 )$$

Where fᵣ is the resonance frequency, L is the effective inductance of the magnetic device, and C is the effective capacitance of the magnetic device. It is therefore desirable to keep the effective capacitance of the magnetic device as low as possible.

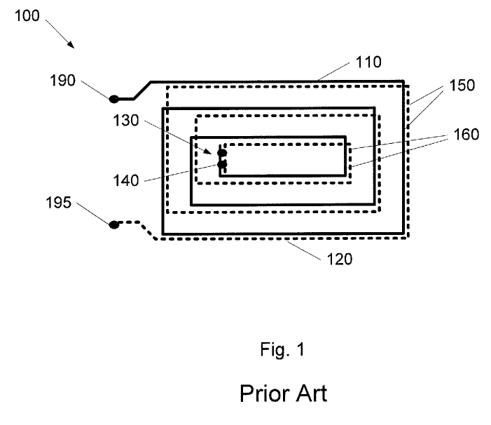

The effective capacitance of a coil may include contributions from various components of the device, such as turn to turn capacitance of turns placed on the same layer, turn to turn capacitance of turns placed on different layers, and other stray capacitances. The contribution of turn to turn capacitance of turns placed on the same layer, as well as the contribution of turn to turn capacitance of turns that are placed on different layers, but are physically distant from each other may be negligible. Therefore, the main contribution to the turn to turn capacitance may come from adjacent turns placed on different layers. Referring to FIG. 1, outermost turns 150 and innermost turns 160 may represent pairs of adjacent turns placed on different layers. As a non binding example, outermost turns 150 and/or innermost turns 160 may partly or substantially overlap.

The effective capacitance of a coil may also depend upon the voltages across these capacitance contributors. As the voltage across a capacitance contributor increases, the effective capacitance of that capacitance contributor increases, and as a result the effective capacitance of the coil increases. As used herein, the term capacitance contributor may refer to a physical section or element of a coil of a magnetic device that has an effective capacitance that contributes to the overall effective capacitance of the coil. Embodiments of the present invention may be aimed at decreasing the turn to turn effective capacitance of adjacent turns placed on different layers, which is considered as a significant contributor to the overall effective capacitance of the coil. According to embodiments of the present invention, the turn to turn effective capacitance of adjacent turns placed on different layers may be decreased by decreasing the voltage across the layers. As used herein the term ‘turn to turn voltage drop’ will refer to turn to turn voltage drop across adjacent turns placed on different layers.

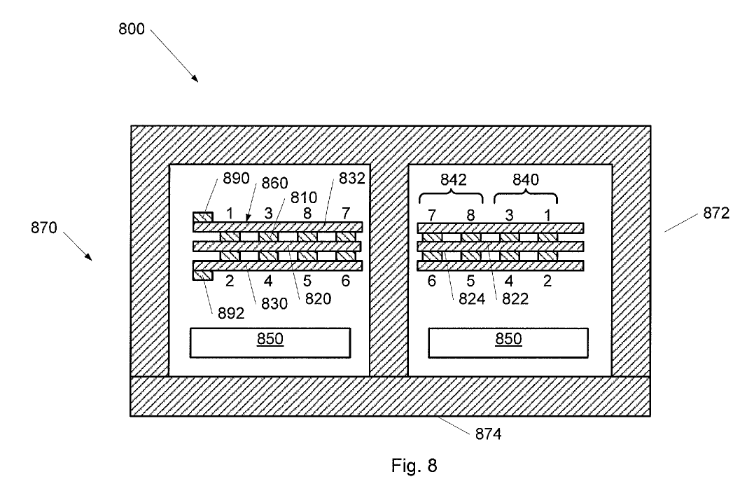

As used herein, a conductive layer may refer to a plurality of turns of the coil that are arranged in substantially the same plain. For example, when separated by a dielectric insulating sheet each conductive layer may include conductors arranged on a single side of the insulating sheet, and when as an example, placed in an EI shape core, the plain of the conductive layers may be substantially parallel to the I section of the core, and substantially perpendicular to the prongs of the E section of the core. The term ‘EI shape core’ is used throughout the specification to describe coil core having two or three or more prongs of a magnetic material connected to one common magnetic conductor (this is symbolized by the character ‘E’) and additional magnetic element, substantially straight, used to close the magnetic path of those prongs (symbolized by the character ‘I’), as seen in FIG. 8. The term ‘EE shape core’ is used throughout the specification to describe a variation of the EI shape core in which the I section of the core is replaced by another E element. A turn may refer to a complete, a nearly complete or a slightly more than complete wrap around of conducting material of the coil. As used herein, a dielectric insulating sheet may refer to a layer of electrically insulating material, used to electrically insulate the conductive layers of the coil from each other. The insulating sheet may be rigid or flexible, and typically thin. For example, the dielectric insulating sheet may be a substrate such as a dielectric substrate layer of a printed circuit board (PCB). The dielectric insulating sheet may be made of any suitable material such as polytetrafluoroethylene (e.g. Teflon® Polytetrafluoroethylene), Nomex® polymer, FR-4, FR-1, CEM-1 or CEM-3 etc., typically laminated together with epoxy resin prepreg, or flexible material such as poly(4,4′-oxydiphenylene-pyromellitimide), e.g. Kapton® polyimide. As used herein, a PCB may be a double-sided board or multi-layer (ML) board.

According to embodiments of the present invention, a coil of a magnetic device may have its turns of conducting material disposed over a plurality of conductive layers, wherein at least two non-innermost and electrically consecutive turns of the coil are disposed over different conductive layers.

Coils according to embodiments of the present invention may be winded over a magnetic core, such as a ferrite core. For example, coils according to embodiments of the present invention may be placed in an EI shape core (as seen in FIG. 8) or an EE core, such that the coil is winded over the central prong of the core.

A primary coil according to embodiments of the present invention may be inductively coupled to at least one secondary coil according to embodiments of the present invention to form a magnetic device such as a transformer, common mode choke, etc.

Referring again to FIG. 1, the turn to turn voltage drop may be related to a voltage drop across planar coil 100. As the resistance of a conductor increases with the length of the conductor extending from the measuring point, the voltage drop across two points of the conductor increases as the length of the conductor between these two points increases. Thus, the turn to turn voltage drop may vary along coil 100. When averaged across turns, turn to turn voltage drop may be maximal at the outermost turns 150, as the length of the conductor between these two turns is maximal. Turn to turn voltage drop, measured along an imaginary line extending radially from the outer perimeter to the center of the spiral windings, may decrease as conductor 110 spirals inwardly and be minimal at the innermost turns 160.

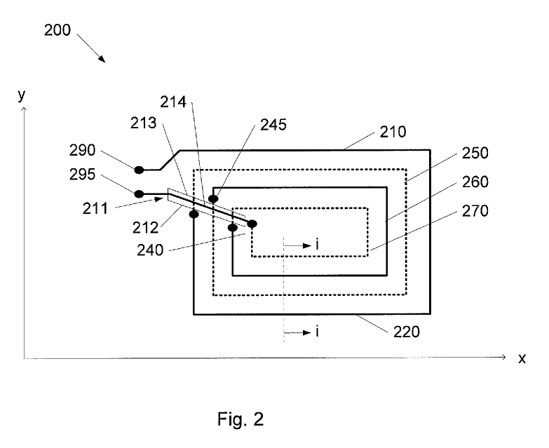

Reference is made to FIG. 2 depicting a schematic top view illustration of an exemplary double layer planar coil 200 according to embodiments of the present invention. According to embodiments of the present invention, planar coil 200 may include a conductor 210 having inward spiral turns. The solid lines represent turns arranged in a first conductive layer, and the dashed lines represent turns arranged in a second conductive layer. For purposes of clarity of the presentation, turns of coils throughout the application, are numbered starting from the outermost winding turn and continuing inwardly. The outermost winding turn may be connected to a first terminal (may also be referred to as tap), such as terminal 290. According to embodiments of the present invention, a first turn 220 of planar coil 200 may be arranged in a first conductive layer, a second turn 250 may be arranged in second conductive layer, a third turn 260 may be again arranged in the first conductive layer, a fourth turn 270 may be arranged in the second conductive layer, and so on, such that planar coil 200 may alternate layers between the first and the second conductive layer as it spirals inwardly. According to the embodiment presented in FIG. 2 each turn may be arranged in a conductive layer different than that of its previous turn.

In a coil of a magnetic device, according to embodiments of the present invention, as demonstrated, for example, in FIG. 2, the turn to turn voltage drop may be substantially lower compared with turn to turn voltage drop of the prior art arrangements, for example, the arrangement of FIG. 1. In planar coil 200, the length of the conductor between each adjacent turns in a pair of turns placed, each of the turns, on different conductive layers is dramatically lower, compared with the length of conductor between adjacent turns in a pair of turns placed, each, on different conductive layers according to the prior art. This effect is maximized for the outermost pair of turns, which includes first turn 220 and second turn 250. According to the prior art arrangement, these two turns could have a considerable length of conductor between them, wherein according to embodiments of the present invention, these are electrically consecutive turns.

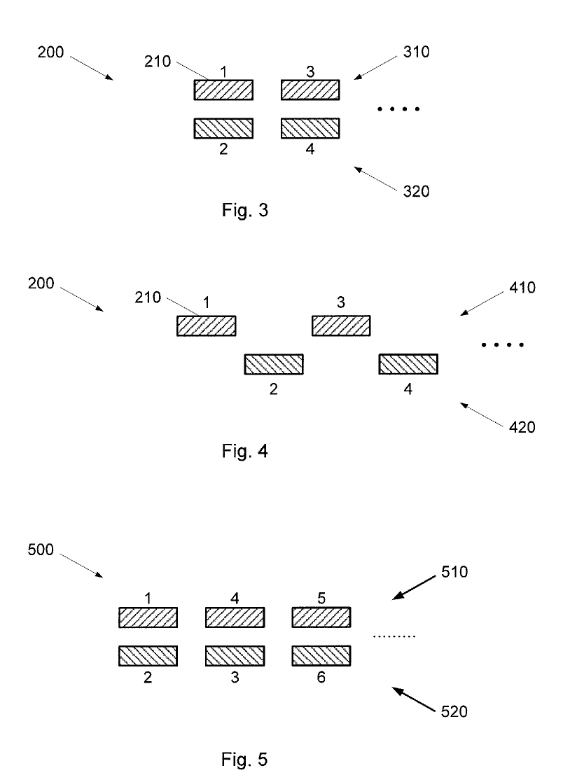

It should be noted that turns 220 and 260 arranged in the first conductive layer and electrically consecutive turns 250 and 270, respectively, arranged in the second conductive layer are shown shifted with relation to each other for clarity of presentation only. While this embodiment is within the scope of the present invention, the present invention is not limited in this regard. For example, electrically consecutive turns, arranged in different conductive layers may partially or substantially fully overlap. An example of substantially fully overlapping electrically consecutive turns is shown in FIG. 3 and an example of shifted electrically consecutive turns is shown in FIG. 4.

In many applications, it is desirable to have the terminals at both ends of the windings of planar coil 200 placed at the outer circumference of planar coil 200. Placing these terminals of planar coil 200 at the outer circumference of the coil may enable easy connection to other components of an electrical circuit. However, conductor 210 of planar coil 200 has inward spiral turns which end at an inner point 240 of planar coil 200. According to embodiments of the present invention, a “free passage corridor” 211 may be formed on a selected conductive layer of planar coil 200. Corridor 211 may be an elongated, radially extending section free of coil turns crossing through it, having its longitudinal dimension stretching at least from inner point 240 of planar coil 220 to terminal 295. Corridor 211 may be formed to allow free passage of conductor 210 from inner point 240 to a terminal 295 disposed at or out of the outermost turn located on the same conductive layer. Corridor 211 may be formed on any conductive layer of planar coil 200. For example, corridor 211 may be formed on the first conductive layer, by arranging so that conductor 210 will switch conductive layers at the end of turns that are arranged in the first conductive layer at first edge 212 of corridor 211, and that conductor 210 will switch conductive layers at the end of turns that are arranged in the second conductive layer at a second edge 213 of corridor 211. Segment 214 of conductor 210 may extend outwardly from inner point 240 to terminal 295 through corridor 211.

It should be readily understood that while the technique for creating a free passage corridor was demonstrated for double layer coil, this technique may be easily implemented according to embodiments of the present invention, to a coil having any number of conductive layers.

Conductor 210 may be implemented as frames of conductive metal, such as copper, brass, aluminum, or various alloy frames, etc, disposed on and/or separated by a dielectric insulating sheet (not shown). Alternatively, conductor 210 may be disposed on two sides of a dielectric insulating sheet or a substrate (not shown), such as the dielectric layer of a PCB. If conductor 210 is disposed on a dielectric layer of a PCB, electrically consecutive turns may be electrically interconnected through vias, such as via 245.

Optionally, two external dielectric insulating sheets may be added, one on each side of coil 200, substantially parallel to ‘x-y’ plain, to cover the exposed sides of conductor 210, which may hare substantial surface area. The additional dielectric insulating sheets may include terminals 290 and 295, and may substantially insulate coil 200 and contribute to reducing undesired electromagnetic interference (EMI) of coil 200.

Reference is made to FIG. 3 depicting a schematic partial cross section illustration of exemplary double layer planar coil 200 according to embodiments of the present invention. FIG. 3 presents a cross section of exemplary double layer planar coil 200 along section line i-i marked on FIG. 2. The partial cross section view of FIG. 3 presents an exemplary arrangement of conductor 210 across the different conductive layers, where right diagonal lines represent cross section of turns arranged in a first conductive layer 310 while left diagonal lines represent cross section of turns arranged in a second conductive layer 320. Numbers adjacent to conductors represent serial number of turns. According to the embodiment presented in FIG. 3, each turn is arranged in a conductive layer different than that of the previous turn, thus, pairs of electrically consecutive turns may be arranged in different conductive layers. Additionally, pairs of electrically consecutive turns, such as turns 1 and 2, and turns 3 and 4, substantially overlap when seen from the top view. While this arrangement may save space, embodiments of the present invention are not limited in this regard, and pairs of electrically consecutive turns may be placed shifted with relation to each other, as will be demonstrated in the embodiment presented in FIG. 4, or partially shifted with relation to each other.

Reference is made to FIG. 4 depicting a schematic partial cross section illustration of exemplary double layer planar coil according to embodiments of the present invention. FIG. 4 presents a second exemplary cross section of double layer planar coil 200 at plain ii marked on FIG. 2. The partial cross section view of FIG. 4 presents a second exemplary arrangement of conductor 210 across the first and second conductive layers, where right diagonal lines represent cross section of turns arranged in a first conductive layer 410 while left diagonal lines represent cross section of turns arranged in a second conductive layer 420. Numbers adjacent to conductors represent serial number of turns. Similarly to the embodiment presented in FIG. 3, each turn is arranged in a conductive layer different than that of the previous turn; however the turns arranged in second conductive layer 420 are shifted with relation to the turns arranged in first conductive layer 410.

Reference is made to FIG. 5 depicting a schematic partial cross section illustration of exemplary double layer planar coil 500 according to embodiments of the present invention. Right diagonal lines represent cross section of turns arranged in a first conductive layer 510 while left diagonal lines represent cross section of turns arranged in a second conductive layer 520. Numbers adjacent to conductors represent serial number of turns. According to the embodiment presented in FIG. 5, a first turn of planar coil 500 may be arranged in first conductive layer 510, a second and a third turns of planar coil 500 may be arranged in second conductive layer 520, a fourth and a fifth turns of planar coil 500 may be arranged in first conductive layer 510, and so on, such that planar coil 500 may alternate conductive layers every two turns.

To this point, embodiments of the present invention where described with relation to a double layer planar coil. However, embodiments of the present application may be augmented to encompass any number of conductive layers as will be demonstrated hereinbelow.

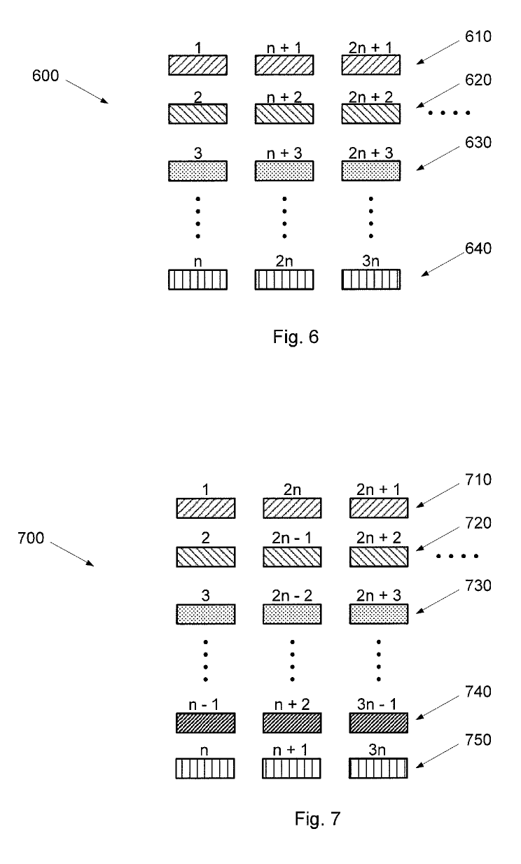

Reference is made to FIG. 6 depicting a schematic partial cross section illustration of exemplary n-layer coil 600 according to embodiments of the present invention. Right diagonal lines represent cross section of turns arranged in a first and external conductive layer 610, left diagonal lines represent cross section of turns arranged in a second conductive layer 620, dots represent cross section of turns arranged in a third conductive layer 630 and vertical lines represent cross section of turns arranged in an n^{th} and external conductive layer 640. Numbers adjacent to conductors represent serial number of turns, and n denotes the number of conductive layers. n may be any positive whole number larger than 1. According to the embodiment presented in FIG. 6, a first turn of coil 600 may be arranged in first conductive layer 610, a second and a third turns of coil 600 may be arranged in second conductive layer 620, a third turn of coil 600 may be arranged in third conductive layer 630, and an n^{th} turn may be arranged in the n^{th} conductive layer 640, the n+1 turn of coil 600 may be again arranged in first conductive layer 610, the n+2 turn of coil 600 may be arranged in second conductive layer 620, the n+3 turn of coil 600 may be again arranged in third conductive layer 630, and the 2n turn of coil 600 may be again arranged in 2n conductive layer 640, and so on. Generally, the conductor of coil 600 may change conductive layers at the end of turns and return to the first conductive layer after reaching the n^{th} layer, as coil 600 spirals inwardly, where the first and the n^{th} conductive layers are external conductive layers.

Reference is made to FIG. 7 depicting a schematic partial cross section illustration of exemplary n-layer coil 700 according to embodiments of the present invention. Right diagonal lines represent cross section of turns arranged in a first and external conductive layer 710, left diagonal lines represent cross section of turns arranged in a second conductive layer 720, dots represent cross section of turns arranged in a third conductive layer 730, vertical lines represent cross section of turns arranged in an n^{th} and external conductive layer 750, and dense right diagonal lines represent cross section of turns arranged in an n−1 conductive layer 740. Numbers adjacent to conductors represent serial number of turns, and n denotes the number of conductive layers. n may be any positive whole number larger than 1. According to the embodiment presented in FIG. 7, a first turn of coil 700 may be arranged in first conductive layer 710, a second turn of coil 700 may be arranged in second conductive layer 720, a third turn of coil 700 may be arranged in a third conductive layer 730, and an n^{th} turn may be arranged in the n^{th} conductive layer 750, the n+1 turn of coil 700 may continue on the n^{th} conductive layer 750, the n+2 turn of coil 700 may be arranged in n−1 conductive layer 740, the 2n−1 turn of coil 700 may be arranged in second conductive layer 720, and the 2n and 2n+1 turns of coil 700 may be arranged in first conductive layer 710, and so on. Generally, the conductor of coil 700 may change conductive layers at the end of turns, except for turns arranged in the first and n^{th} conductive layers, where the first and the n^{th} conductive layers are external conductive layers, as coil 700 spirals inwardly.

Coils 500, 600 and 700 presented in FIGS. 5, 6, and 7, respectively, may be implemented as frames of conductive metal, such as copper, brass, aluminum, or various alloy frames, separated by a dielectric insulating sheet (not shown). 500, 600 and 700 may be disposed on a single layer or multi layer dielectric substrate (not shown), such as the dielectric layers of a PCB. If disposed on dielectric layers of a PBC, electrically consecutive turns may be electrically interconnected through vias.

Optionally, two external dielectric insulating sheets may be added to cover the exposed sides of the coils. The additional dielectric insulating sheets may include the terminals (not shown) of coils 500, 600 and 700, and may substantially insulate coils 500, 600 and 700 and contribute to reducing undesired electromagnetic interference (EMI) of coils 500, 600 and 700.

It should be noted that coils of magnetic devices, in which some of the turns are arranged as described hereinabove, while other turns are arranged differently, for example, according to prior art arrangements, are also within the scope of the current application. For example, at least one pair of electrically consecutive turns of a multilayer coil, other than the innermost turns, may be disposed over different conductive layers, while the other turns may spiral inwardly and outwardly on different conductive layers according to the prior art arrangement. It would typically be desirable to have the outermost electrically consecutive turns of the multilayer coil disposed over different conductive layers according to embodiments of the present invention, since it is believed that the outermost turns have a considerable contribution to the overall effective capacitance of the coil. A hybrid arrangement as described hereinabove may decrease the overall effective capacitance of the coil, while largely maintaining the simplicity of the prior art arrangement. For example, if implemented on a PCB, a hybrid arrangement as described hereinabove may decrease the overall effective capacitance of the coil, while keeping the number of required vias low, when compared with the prior art arrangement.

Additionally, according to the examples given hereinabove, the conductor turns change conductive layers according to an organized pattern, typically moving to an adjacent conductive layer at the end of each turn. It should be noted, however, that embodiments of the present invention are not limited to the specific patterns demonstrated herein. Hence, a coil according to embodiments of the present invention may change conductive layers according to any desired schema. Similarly, the specific layout of the turns of coils according to embodiments of the present inventions is not limited to the demonstrative layouts presented herein and may vary to meet specific design requirements.

Coils according to embodiments of the present invention me be implemented in a variety of magnetic devices. For example, at least one coil of a transformer, an integrated magnetic device (e.g. a device comprising a transformer and a plurality of chokes winded over a single ferrite core, also referred to as an hybrid inductors-transformers) and other magnetic devices may be implemented according to embodiments of the invention as described herein.

Reference is now made to FIG. 8 depicting a schematic cross section illustration of an exemplary magnetic device 800 assembled within an EI core 870 according to embodiments of the present invention. EI core 870 may comprise an E shaped magnetic element 872 and an I shaped magnetic element 874. Magnetic device 800 may include a primary coil 860, inductively coupled to at least one secondary coil 850, thus forming a transformer or a common mode choke. At least one of coils 860 and 850 may be implemented according to embodiments of the present invention as described hereinabove. For example, primary coil may be implemented as a hybrid coil. According to embodiments of the present invention, coil 860 may comprise a conductor 810 having inward spiral turns disposed on an insulating sheet 820, such as a dielectric layer of a PCB. A first layer of conductor may be disposed on a first side 822 of insulating sheet 820, while a second layer of conductors may be disposed on a second side 824 of insulating sheet 820. When placed in an EI core, the conductive layers are substantially parallel to the I section of the core, and substantially perpendicular to the prongs of the E section of the core.

Coil 860 may include a first part 840 in which each turn is arranged in a different conductive layer than the previous turn, similarly to the embodiment presented in FIG. 2, and a second part 842 in which inward spiral turns are arranged in a first conductive layer 822 and outward spiral turns are arranged in a second conductive layer 824, similarly to the prior art arrangement presented in FIG. 1.

Coil 860 may include two external dielectric insulating sheets 830 and 832, deposited on the exposed side of the two conductive layers of conductor 810. Insulating sheets 830 and 832 may include terminals 890 and 892 of coil 860, and may substantially insulate coil 860 and contribute to reducing undesired electromagnetic interference (EMI) of coil 860.

It should be noted that coil 860 is shown by way of example only and coils of embodiments of the present invention may be disposed on a multi-layer PCB having more than two conductive layers. Additionally, primary coil 860, and at least one secondary coil 850 may be disposed on the same PCB, for example, on different layers of the same PCB. Furthermore, only a single coil may be placed in a single core. Embodiments of the present invention are not limited to a specific core design. Other core shapes may be utilizes, or alternatively, no core may be used. In addition, a core may be added to coils made from metallic frames and arranged according to embodiments of the present invention.

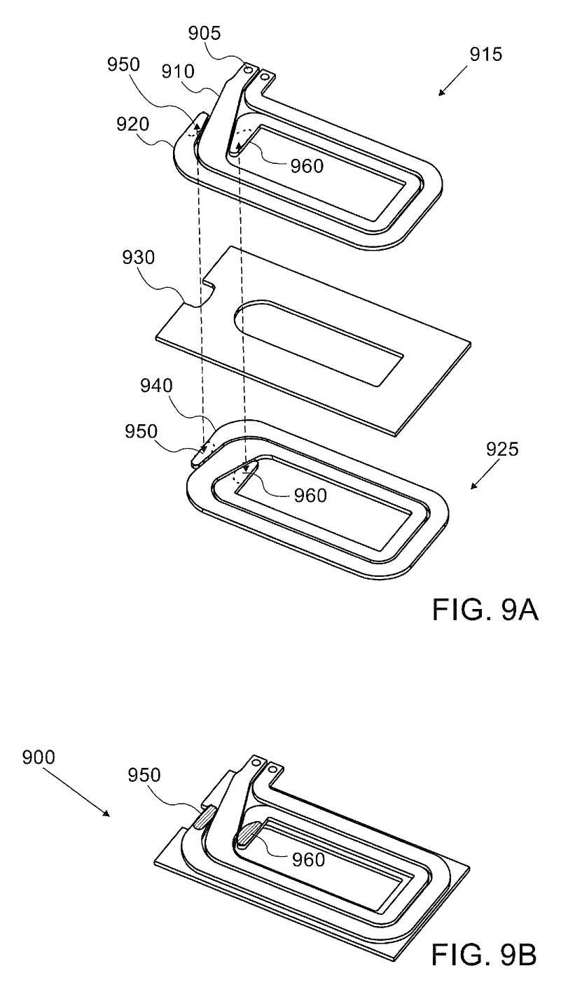

Reference is now made to FIGS. 9A and 9B depicting an exemplary isometric exploded view, and isometric assembled view, respectively, of a lead-frame coil 900 according to embodiments of the present invention. Coil 900 may include, for example, two conductive layers 915 and 925, and an insulating sheet 930 there between. Each one of conductive layers 915 and 925 may include, as a non-binding example, two coil turns. First conductive layer 915 may include an outermost conductor turn 920 and an innermost conductor turn 910. Outermost turn 920 may be electrically connected, e.g. by welding or any other suitable technique, at welding point 950, to an outermost turn of conductor 940 of second conductive layer 925. Conductor 940 may spiral inwardly and be electrically connected, at welding point 960, to innermost turn 910 of first conductive layer 915. A segment of innermost turn 910 may extend outwardly towards terminal 905. Welding points 950 are marked both on outermost turn 920 and conductor 940 at the region where they are eventually connected. Similarly, welding points 960 are marked both on innermost turn 910 and on conductor 940 at the region where they are eventually connected.

Coils of magnetic devices according to embodiments of the present invention, as described hereinabove may be planar, e.g., having low physical profile, with relatively larger length and width in relation to thickness or height. Where the length and width are generally measured along the ‘x-y’ plain depicted in FIG. 2 and height is measured along a ‘z’ axis (not shown), perpendicular to the x-y plain. However, embodiments of the present invention are not limited in this regard and may include coils of magnetic devices having any dimensions. The specific dimensions of coils and magnetic devices according to embodiments of the present invention may be chosen to meet specific design requirements.

It should be noted that embodiments of the current invention are not limited to the specific examples presented hereinabove, and that implementations of the principles described herein may vary as may be required to meet specific design requirements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A coil of a magnetic device comprising a conductor comprising a plurality of turns arranged in a plurality of conductive layers, wherein at least two non-innermost and electrically consecutive turns of the conductor are arranged in different conductive layers.

2. The coil of claim 1, wherein each pair of adjacent conductive layers is separated by a dielectric insulating sheet.

3. The coil of claim 1, wherein the coil is planar.

4. The coil of claim 1, wherein the plurality of turns are arranged as inward spiral turns.

5. The coil of claim 3, wherein the conductor changes conductive layers at ends of the turns and returns to a first external conductive layer after reaching a second external conductive layer, as the coil spirals inwardly.

6. The coil of claim 3, wherein the conductor changes conductive layers at ends of the turns except for turns arranged in external conductive layers, as the coil spirals inwardly.

7. The coil of claim 1, comprising terminals at both ends of windings of the coil, wherein the terminals are placed at an outer circumference of the coil.

8. The coil of claim 6, wherein a free passage corridor is formed on a selected conductive layer of the coil, the corridor being a radially extending section free of the plurality of turns, a longitudinal dimension of the corridor stretches at least from an inner point of the coil to a first terminal, wherein a segment of the conductor extends outwardly from the inner point to the first terminal through the corridor.

9. The coil of claim 1, wherein the dielectric insulating sheet is a substrate layer of a printed circuit board (PCB).

10. The coil of claim 1, implemented as frames of conductive metal.

11. The coil of claim 1 wherein the dielectric insulating sheet is made of a material selectable from the list consisting of: polytetrafluoroethylene, Nomex® polymer, FR-4, FR-1, CEM-1 or CEM-3 and poly(4,4′-oxydiphenylene-pyromellitimide).

12. The coil of claim 1, comprising a magnetic core, wherein the coil is winded over the core.

13. The coil of claim 12, wherein the magnetic core is an EI core, and wherein the coil is winded over the central prong of the core.

14. The coil of claim 12, wherein the magnetic core is a ferrite core.

15. A magnetic device comprising:
a plurality of coils, at least two of the coils being inductively coupled to each other,
wherein at least one of the coils comprises a conductor having its plurality of turns arranged in a plurality of conductive layers, wherein at least two non-innermost and electrically consecutive turns of the conductor are arranged in different conductive layers.

16. The magnetic device of claim 15, wherein each pair of adjacent conductive layers is separated by a dielectric insulating sheet.

17. The magnetic device of claim 15, wherein the plurality of turns of the conductor of the at least one coil are arranged as inward spiral turns.

18. The magnetic device of claim 15, wherein the conductor of the at least one planar coil changes conductive layers at ends of the turns and return to a first external conductive layer after reaching a second external conductive layer, as the at least one planar coil spirals inwardly.

19. The magnetic device of claim 15, wherein the conductor of the at least one planar coil changes conductive layers at ends of the turns except for turns arranged in external conductive layers, as the at least one planar coil spirals inwardly.

20. The magnetic device of claim 15, wherein the magnetic device is selected from the list consisting of: a transformer and an integrated magnetic device.
